(19) United States
(12) Patent Application Publication
(10) Pub. No.: US 2012/0217356 A1
(43) Pub. Date: Aug. 30, 2012

(54) BROADBAND MONITORING CAMERA

(76) Inventors: Chan Duk Park, Seoul (KR); Ung Do Park, Seoul (KR)

(21) Appl. No.: 13/502,369

(22) PCT Filed: Oct. 15, 2010
(86) PCT No.: PCT/KR10/07096

§ 371 Date: Apr. 16, 2012

(30) Foreign Application Priority Data
Oct. 16, 2009 (KR) 10-2009-0098805

(51) Int. Cl. F16M 11/18

(52) U.S. Cl. 248/122.1

(57) ABSTRACT

The present invention relates to a broadband monitoring camera and comprises: a main camera; a plurality of auxiliary cameras which are installed around the main camera to photograph a blind spot which is not photographed by the main camera; a rotational mount for providing a loading space in which the main camera can be rotated in an upper direction, a lower direction, a left direction, and a right direction; a loading mount for preparing a loading space on which the rotational mount can be loaded; auxiliary brackets which are coupled with the rotational mount to prepare a coupling space on which the auxiliary cameras can be loaded; and auxiliary camera supporters coupled with the auxiliary brackets on which the auxiliary cameras are loaded. The auxiliary camera supporters are characterized by enabling the auxiliary cameras to be rotated in the upper direction, the lower direction, the left direction, and the right direction and maintaining a fixed state thereof in a particular position.

### TECHNICAL FIELD

The present invention relates to a broadband monitoring camera, and in particular to a broadband monitoring camera which is installed in a street, thus monitoring the movements of a thing in an automatic or a manual mode.

### BACKGROUND ART

A lot of broadband monitoring cameras are installed in an alley or a crossroad for the purpose of preventing crimes.

The broadband monitoring camera is directed to a system automatically tracing the movements of a thing, so the movements of a thing can be automatically traced and monitored.

In the event that a broadband monitoring camera is directed to tracing the movements of a thing, the broadband monitoring camera might miss the movements of another thing which appears in a dead zone of the broadband monitoring camera.

In order to resolve the above mentioned problems, a new broadband monitoring camera system is developed, which is characterized in that an assistant camera is installed at a lateral side and a backside of a main camera, thus monitoring the dead zones of a main camera.

The camera system in which an assistant camera is attached at a lateral side and a backside of a main camera is configured in such a way that an assistant camera is integrally coupled with a main camera. In this case, the assistant camera is impossible to adjust its photographing angle depending on the conditions of an installed region.

The assistant camera installed at a lateral side or a backside of a broadband monitoring camera often used to miss a thing near an image that is zoomed in and viewed by a monitoring camera while the monitoring camera zooms in and views a thing which is being traced.

### DISCLOSURE OF INVENTION

Accordingly, it is an object of the present invention to provide a broadband monitoring camera which makes it possible to adjust a photographing angle of an assistant camera which is installed around a main camera.

It is another object of the present invention to provide a broadband monitoring camera which is possible to monitor the surrounding situations of a thing with the aid of a zoomed-in monitoring as a main camera zooms in and monitors the movements of a thing.

To achieve the above objects, there is provided a broadband monitoring camera which comprises a main camera; a plurality of assistant cameras which are installed near the main camera and serve to photograph a dear zone that the main camera cannot photograph; a rotary type mounting part which provides a mounting space to the main camera for the main camera to rotate in the upward direction, the downward direction, the leftward direction and the rightward direction; a mounting and engaging part which provides a mounting space for mounting the rotary type mounting part; an assistant bracket which is engaged to the rotary type engaging part and provides a space for mounting the assistant cameras; and an assistant camera support part which is engaged to the assistant bracket and mounts the assistant cameras, wherein the assistant camera support parts are disposed for the assistant cameras to rotate in the upward direction, the downward direction, the leftward direction and the rightward direction, and the assistant camera support parts are engaged to the rotary type engaging part together with the assistant brackets and rotate or are fixed irrespective of the rotations of the rotary type engaging part as they are engaged to the mounting and engaging part together with the assistant brackets, so the assistant camera support parts can rotate or can be fixed.

In this case, the each assistant camera support part comprises a first lateral surface part in which a first support hole is formed; a second lateral surface part in which a second support hole is formed; and a support part which connects the first lateral surface part and the second lateral surface part and in which a third support hole is formed, wherein the first lateral surface part and the second lateral surface part are bent at both ends of the support part, and the assistant cameras are bolt-engaged via the first support hole and the second support hole in a state that they are arranged between the first lateral surface part and the second lateral surface part, and the support part is characterized in that the bolt passing through the third support hole is bolt-engaged with the assistant bracket.

Here, the first support hole and the second support hole are formed in a straight line shape.

Meanwhile, the broadband monitoring camera further comprises a first gear which is engaged with the rotary type engaging part; a second gear which is spaced apart from the rotary type engaging part; a first motor of which a motor shaft is engaged to the second gear and which is fixed at the mounting and engaging part; a first belt which synchronically drives the first gear and the second gear; a third gear of which a central shaft is inserted into the rotary type engaging part; a fourth gear which is spaced apart from the third gear; a second motor of which a motor shaft is engaged with the fourth gear and which is fixed at the rotary type engaging part; and a second belt which synchronically drives the third gear and the fourth gear.

### ADVANTAGEOUS EFFECTS

The present invention is advantageously characterized in that an assistant camera installed around a main camera is fixed in such a way to be adjustable in a vertical direction and a horizontal direction by means of an assistant camera support part for the purpose of ensuring that a photographing camera of an assistant camera can be easily adjusted depending on a topography of an installed region in the event that a broadband monitoring camera is installed.

The present invention makes it possible to facilitate a widened monitoring range of a broadband monitoring camera now what a dead zone that a main camera cannot photograph in the event that a main camera is in the mode that it zooms in a thing.

### BRIEF DESCRIPTION OF DRAWINGS

FIG. 1 is a perspective view illustrating a broadband monitoring camera according to an embodiment of the present invention.

FIG. 2 is a perspective view illustrating an inner construction by cutting away an engaging part of a camera of FIG. 1.

FIG. 3 is a disassembled perspective view of an assistant camera, an assistant bracket and an assistant camera support part of FIG. 1.

FIG. 4 is a perspective view illustrating a horizontal direction rotation state of an assistant camera in a state that the constructions of FIG. 3 are engaged.

FIG. 5 is a perspective view illustrating a vertical direction rotation state of an assistant camera in a state that the constructions of FIG. 3 are engaged.

FIG. 6 is a front view illustrating a broadband monitoring camera according to another embodiment of the present invention.

FIG. 7 is a plane view illustrating a broadband monitoring camera of FIG. 6.

### MODES FOR CARRYING OUT THE INVENTION

The preferred embodiments of the present invention will be described in details with reference to the accompanying drawings.

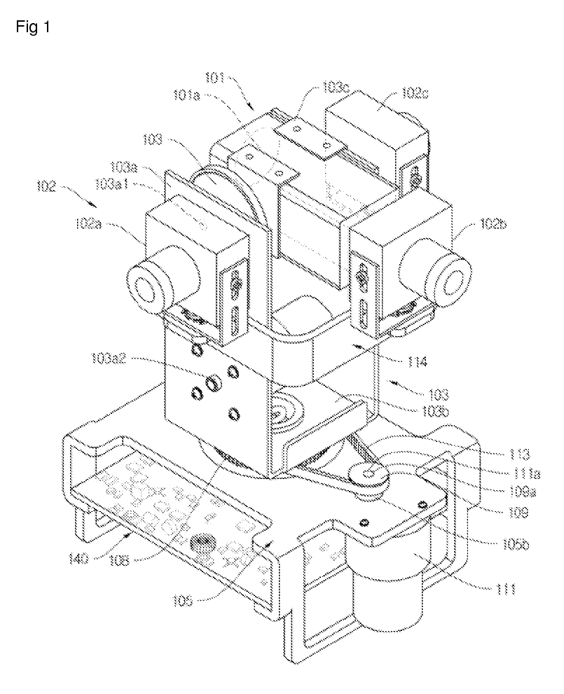

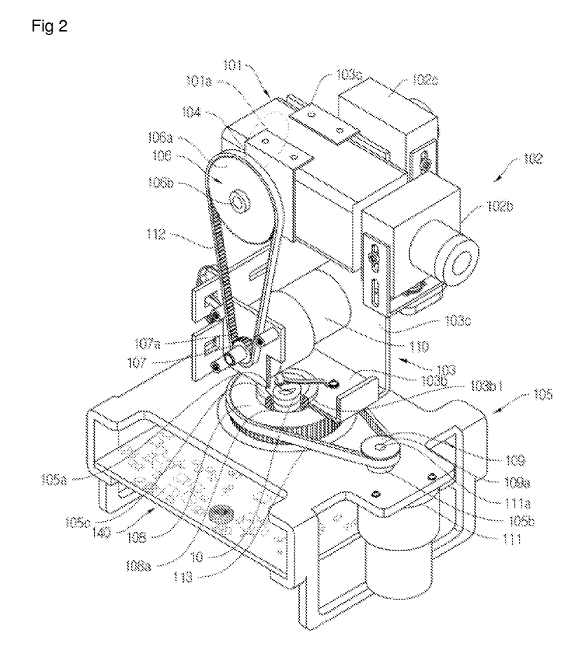

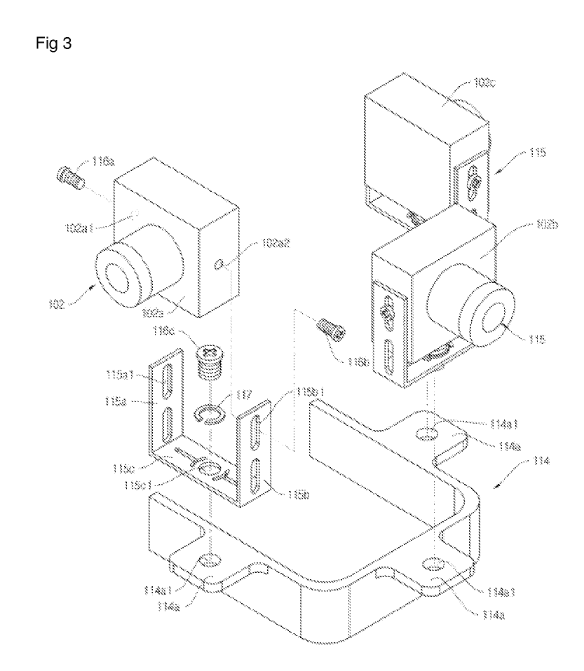

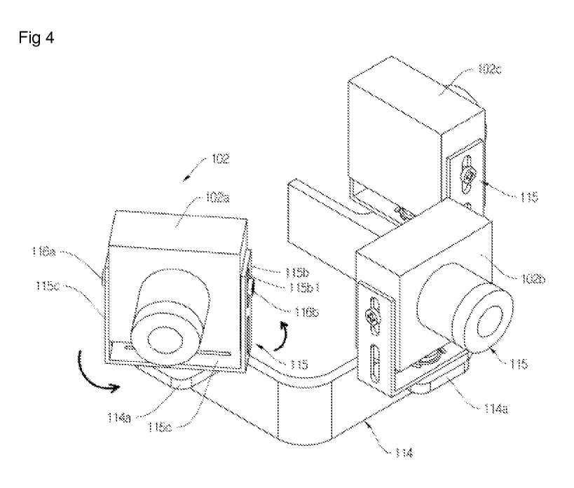

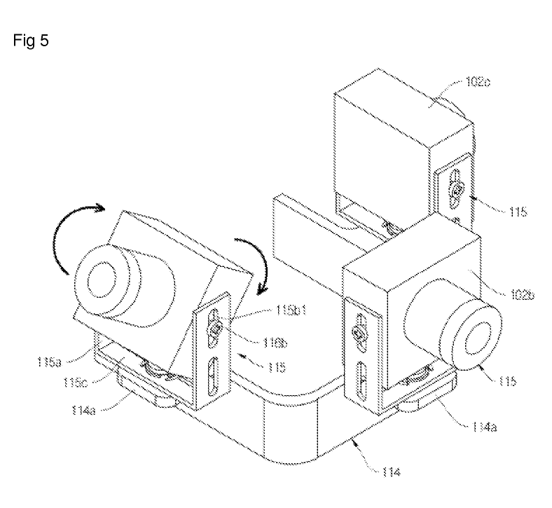

FIG. 1 is a perspective view illustrating a broadband monitoring camera according to an embodiment of the present invention. FIG. 2 is a perspective view illustrating an inner construction by cutting away an engaging part of a camera of FIG. 1. FIG. 3 is a disassembled perspective view of an assistant camera, an assistant bracket and an assistant camera support part of FIG. 1. FIG. 4 is a perspective view illustrating a horizontal direction rotation state of an assistant camera in a state that the constructions of FIG. 3 are engaged. FIG. 5 is a perspective view illustrating a vertical direction rotation state of an assistant camera in a state that the constructions of FIG. 3 are engaged.

As shown in FIGS. 1 through 5, the camera according to an embodiment of the present invention comprises a main camera 101, an assistant camera 102, a rotary type engaging part 103, a main camera engaging part 104, a mounting engaging part 105, a first gear 106, a second gear 107, a third gear 108, a fourth gear 109, a first motor 110, a second motor 111, a first belt 112, a second belt 113, an assistant bracket 114, an assistant camera support part 115 and a bolt.

The main camera 101 is directed to a camera formed of a panning function, a tilting function and a zooming function. The main camera 101, as described earlier, is characterized in that in the automatic tracing monitoring mode, panning/tilting/zooming control parts are automatically controlled by means of a microcomputer 140, thus controlling the panning, tilting and zooming functions. The main camera 101 has a photographing viewing angle of 90° to 100°. Here, the photographing direction of the main camera 101 corresponds to a portion where a lens 110a is formed.

The assistant camera 102 is formed of a first assistant camera 102a, a second assistant camera 102b and a third assistant camera 102c. The assistant camera 102 is directed to a camera which is not equipped with panning, tilting and zooming functions and is relatively smaller than the main camera 101 and is light. Here the assistant camera 102 has a photographing view angle of 90° to 100°, and the photographing view angle is 360° in a horizontal direction as the photographing view angle of the main camera 101 is added thereto.

The first assistant camera 102a is positioned at a portion where the photographing direction is approximately at a right angle from the photographing direction of the main camera 101 for the purpose of ensuring that the photographing view angle becomes approximately a right angle from the photographing view angle of the main camera 101.

The second assistant camera 102b is so positioned that the photographing direction is approximately at a right angle from the photographing angle of the main camera 101 and is so positioned that the photographing direction is opposite to the photographing direction of the first assistant camera 102a for the purpose of ensuring that the photographing view angle becomes approximately a right angle from the photographing view angle of the main camera 101.

The third assistant camera 102c is so positioned that the photographing direction is opposite to the photographing direction of the main camera 101 for the purpose of ensuring that the photographing direction becomes approximately 180° from the photographing direction of the main camera 101. The third assistant camera 102c is arranged in a direction opposite to a surface where the lens 110a of the main camera 101 is formed.

The rotary type engaging part 103 is formed of a first surface 103a, a second surface 103b and a third surface 103c.

The first surface 103a is formed of a first gear shaft insertion hole 103a1 into which one end of the gear shaft of the first gear 106 is inserted, and a first motor shaft insertion hole 103a2 into which a motor shaft of the first motor 110 is inserted.

The second surface 103b is connected with the first surface 103a and is bent approximately at a right angle from the first surface 103a, and at the second surface 103b is formed a third gear shaft engaging hole 103b1 to which a gear shaft of a third gear 108 is engaged.

The third surface 103c is connected with the second surface 103b and is bent approximately at a right angle from the second surface 103b. In this case, the third surface 103c is bent facing the first surface 103a, so a rotary type engaging part 103 is formed in an approximately U-shape. In addition, the third surface 103c is formed of a support shaft insertion hole (not shown), into which a main camera support shaft (not shown) is inserted, at a portion facing the first gear shaft insertion hole 103a1.

Here the rotary type engaging part 103 is made from an injection resin or a metallic material.

The main camera engaging part 104 is formed in an approximately U-shape and is inserted into between the first surface 103a and the third surface 103c of the rotary type engaging part 103. The main camera engaging part 104 serves to stably support the main camera 101 by mounting the main camera 101 in a U-shaped concave groove. The main camera engaging part 104 is engaged with the first gear 106 and has a hole (not shown) into which the main camera support shaft (not shown) is inserted, and the hole (not shown) is concentric with the support shaft insertion hole of the third surface 103c.

The mounting engaging part 105 has a central hole 105a at its center. The mounting engaging part 105 has a second motor shaft pass hole 105b at a peripheral portion of the central hole 105a. The mounting engaging part 105 further has a circular protrusion tube 105c schematically vertically protruded from the central hole 105a of the mounting engaging part 105. Into the circular protrusion tube 105c is inserted the third gear hole 108a of the third gear 108. Through a hollow part of the circular protrusion tube 105c pass the main camera 101 and the assistant camera 102 and an electric cable 10 electrically connected with the first motor 110. The electric cable 10 servers to electrically connect the first motor 110 and the second motor 111 with the microcomputer 140.

The first gear 106 is formed of a first gear body 106a and a first gear central shaft 106b engaged with the first gear body 106a. One end of the first gear central shaft 106b is engaged with the main camera engaging part 104. The other end of the first gear central shaft 106b is inserted into the first gear shaft insertion hole 103a1.

The second gear 107 has a second gear hole 107a at its central portion, and the motor shaft of the first motor 110 is inserted into the second gear hole 107a, and the second gear hole 107a is engaged with the motor shaft of the first motor 110, and the second gear 107 is formed in such a way that its teeth are arranged in approximate parallel with the shaft blades of the teeth of the first gear 106.

The third gear 108 has a third gear hole 108a, and a circular protrusion tube 105c is inserted into the third gear hole 108a. The third gear 108 is formed in such a way that the shaft blades of the teeth are approximately vertical to the second surface 103b.

The fourth gear 109 has a fourth gear hole 109a at its central portion, and the fourth gear hole 109a is engaged with the motor shaft 111a of the second motor 111.

The first motor 110 is engaged with the rotary type engaging part 103 by means of an engaging or insertion fitting way using a bolt or other elements. In addition, the first motor 110 is configured as the second gear 107 is engaged to the motor shaft. The first motor 110 is electrically connected with an electric cable 10 passing through the circular protrusion tube 105c. The first motor 110 is electrically connected with the microcomputer 140, and the microcomputer 140 is programmed to operate in an automatic monitoring mode and a manual monitoring mode. In the automatic monitoring mode, the first motor 110 is driven by an automatic tracing algorithm, thus adjusting a vertical photographing direction of the main camera 101.

The second motor 111 is engaged with the mounting engaging part 105 by an engagement using a bolt or engaging elements. In this case, at the motor shaft of the second motor 111 is engaged the fourth gear 109 after it passes through the second motor shaft pass hole 105b of the mounting engaging part 105. The second motor 111 is electrically connected with an electric cable 10 passing through the circular protrusion tube 105c. The second motor 111 is electrically connected with the microcomputer 140, and the second motor 111 is driven depending on an automatic tracing algorithm in the automatic monitoring mode of the microcomputer 140, thus adjusting the horizontal photographing directions of the main camera 101 and the assistant camera 102.

The first belt 112 is formed of a timing belt made from a material containing rubber. The first belt 112 has teeth at its inner surface which teeth are engaged with the teeth of the first gear 106 and the second gear 107. The first belt 112 synchronically drives the second gear 107 when the first gear 106 drives.

The second belt 113 is formed of a timing belt made from a material containing rubber. The second belt 113 has teeth at its inner surface which teeth are engaged with the teeth of the third gear 108 and the second gear 107. The second belt 113 synchronically drives the second gear 107 when the first gear 106 drives.

The assistant bracket 114 is engaged with the rotary type engaging part 103. In this case, the assistant bracket 114 is bent in an approximately laid-down channel shape. Here the assistant bracket 114 further has a wing part 114a. The number of the wing parts 114a is determined depending on the number of the assistant cameras 102. The wing part 114a is protruded from the assistant bracket 114 to in a photographing direction of the assistant camera 102. In the present embodiment of the present invention, three wing parts 114a are provided corresponding to three assistant cameras 102 and are disposed at both lateral sides and a rear side from the photographing direction of the main camera. The wing part 114a has a wing part hole 114a1 to be engaged with a bolt.

The assistant camera support parts 115 are provided in multiple numbers, the number of which is determined corresponding to the number of the wing parts 114a formed at the assistant bracket 114. Each assistant camera support part 115 is engaged with each assistant camera 102. The plurality of the assistant camera support parts 115 are provided in the same structures. In the following descriptions on the assistant camera support part 115, one assistant camera support part 115 will be described for simplification.

The assistant camera support part 115 comprises a first lateral surface part 115a, a second lateral surface part 115b and a support part 115c. Here the first lateral surface part 115a and the second lateral surface part 115b and the support part 115c are integral with one another. The first lateral surface part 115a and the second lateral surface part 116b, which are on the same plane, are bent at both ends of the support part 115c, respectively. In this case, the first lateral surface part 115a has a first support hole 115a1, and the second lateral surface part 115b has a second support hole 115b1 at a portion facing the first support hole 115a1. The first support hole 115a1 and the second support hole 115b1 are opposite to each other and are formed in a row. At this time, the bodies of the first bolt 116a and the second bolt 116b engaged to the assistant camera 102 are inserted into the first support hole 115a1 and the second support hole 115b1, respectively. In this case the first bolt 116b and the second bolt 116b are arranged at the portions in the intermediate portions of the longitudinal directions of the first support hole 115a1 and the second support hole 115b1, and the first bolt 116a and the second bolt 116b are tightened to the assistant camera 102, thus adjusting the height of the assistant camera 102 in the longitudinal directions of the first support hole 115a1 and the second support hole 115b1.

The third support hole 115c1 is formed at the center of the support part 115c. Into the third support hole 115c1 is inserted the body of the third bolt 116c. The body of the third bolt 116c is bolt-engaged to the hole of the wing part 114a in a state that it is inserted in the third support hole 115c1. In this case, a washer 117 is inserted into the body part of the third bolt 116c, thus preventing the loosening of the third bolt 116c.

Here the assistant camera 102 engaged to the assistant camera support part 115 has at its one side a first bolt engaging hole 102a1 to which the body of the first bolt 116a is bolt-engaged, and has at its other side a second bolt engaging hole 102a2 into which the body of the second bolt 116b is bolt-engaged. In this case, the central axes of the first bolt engaging hole 102a1 and the second bolt engaging hole 102a2 are positioned on the straight line. The body of the first bolt 116a is bolt-engaged to the first bolt engaging hole 102a1 formed at one side of the assistant camera 102 in a state that it passes through the first support hole 115a1 of the first lateral surface part 115a, and the body of the second bolt 116b is bolt-engaged to the second bolt engaging hole 102a2 formed at the other side of the assistant camera 102 in a state that it passes through the second support hole 115b1 of the second lateral surface part 115b.

The assistant camera support part 115 was descried to be formed in a laid-down channel shape, but its shape might change in various shapes depending on the number of the assistant cameras. For example, if the number of the assistant cameras is four, the assistant camera support part 115 is formed in a square shape, and one assistant camera is disposed at each side of the square shape construction.

The operations and effects of the structure of the broadband monitoring camera according to an embodiment of the present invention will be described.

The broadband monitoring camera according to an embodiment of the present invention is characterized in that the assistant cameras 102 are directed to photographing both lateral sides and a rear side of the main camera 101 so that the thing not seen from the main camera 101 can be photographed.

Since the assistant cameras 102 are engaged at both lateral sides and a rear side of the main camera 101 with the aid of the assistant brackets 114, they rotate together with the main camera 101 of the rotary type engaging part rotating by means of the first motor. So, the assistant cameras 102 can take the images of a thing within a viewing angle that the main camera 101 cannot photograph as the main camera 101 rotates.

In this case, the assistant camera 102 is engaged to the assistant bracket 114 by means of the assistant camera support part 115. The assistant camera support part 115 can rotate about the third bolt 116c engaged to the support part 115c.

At this time, the assistant camera 102 can take a viewing angle in the left side direction, the central side direction and the right side direction among the lateral side directions of the main camera 101 by means of the rotations of the assistant camera support part 115.

In addition, the assistant camera support part 115 rotates about the first bolt 116a and the second bolt 116b, so it is possible to take a viewing range in the upper side direction, the central side direction and the right side direction among the lateral side directions of the main camera 101.

When a worker installs a broadband monitoring camera according to an embodiment of the present invention at a crossroad, with the broadband monitoring camera being fixed, the assistant camera support part 115 is rotated in the upward, downward, leftward and rightward directions, thus obtaining the photographing angles of the assistant cameras 102 depending on the topography of the road, and the bolts are tightened for fixing the assistant cameras 102, so it is possible to obtain the viewing ranges of the assistant cameras 102 depending on the topography.

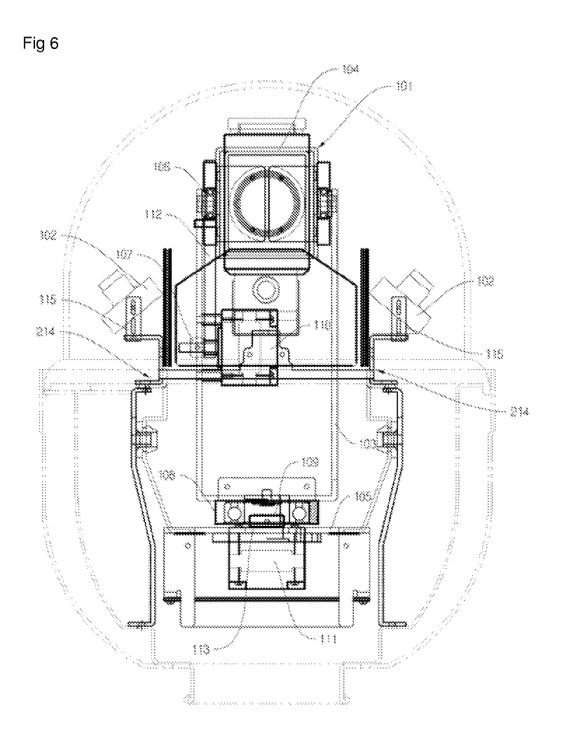

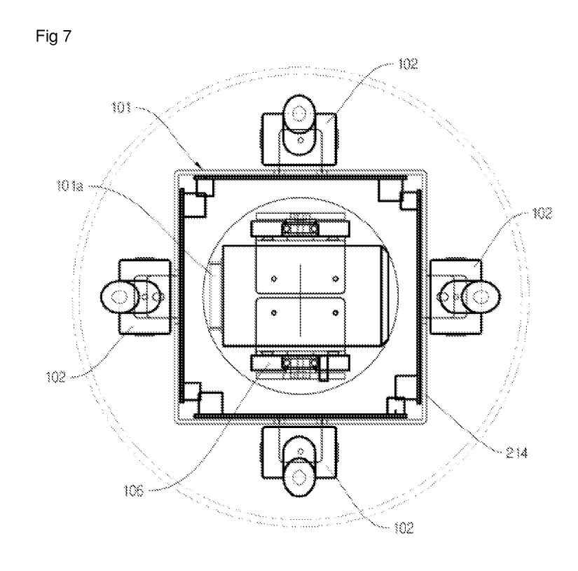

FIG. 6 is a front view illustrating a broadband monitoring camera according to another embodiment of the present invention. FIG. 7 is a plane view illustrating a broadband monitoring camera of FIG. 6.

As shown in FIGS. 6 and 7, the broadband monitoring camera according to another embodiment of the present invention comprises a main camera 101, an assistant camera 102, a rotary type engaging part 103, a main camera engaging part 104, a mounting engaging part 105, a first gear 106, a second gear 107, a third gear 108, a fourth gear 109, a first motor 110, a second motor 111, a first belt 112, a second belt 113, an assistant bracket 214, an assistant camera support part 115 and a belt.

FIGS. 6 and 7 show a transparent material dome covering the broadband monitoring camera and a dome cover in which the dome and the dome cover are shown by an imaginary line.

In the present embodiment of the present invention, the same constructions as the earlier described construction are given the same reference numeral, and the descriptions for the same constructions will be omitted.

The differences between the present embodiment and the earlier described embodiment lie in that the structures and the engaging relationships of the assistant brackets 214 are different.

In the present embodiment of the present invention, the assistant bracket 214 is formed in a square tube shape and accommodates a rotary type engaging part 103 at its inner side.

The assistant bracket 214 is not engaged to the rotary type engaging part 103, but engaged to the mounting engaging part 105. So, the assistant bracket 214 is arranged in a fixed state irrespective of the rotation of the rotary type engaging part 103. In this case, since the assistant camera support part 115 engaged to the assistant bracket 214 is fixed at the assistant bracket 214, the assistant camera 102 remains fixed as well. The shape of the assistant bracket 214 shown in the drawing is bent and is formed of a plurality of elements.

Four assistant cameras 102 are engaged at the four sides of the square tube shape assistant brackets 214 for the purpose of photographing the four directions of the front side direction, the backside direction, the left side direction and the right side direction. So, the assistant cameras 102 are directed to photographing the things positioned in the viewing angle that the main camera 101 cannot photograph as the main camera 101 rotates. In this case, the assistant cameras 102 are fixed to rotate in the leftward and rightward directions and the upward and downward directions, so it is possible to take a viewing range depending on the topography where the broadband monitoring camera is installed.

The assistant camera support parts 115 are so installed that the assistant cameras 102 can take a viewing range in an oblique line, whereby the assistant cameras 102 can be installed in the interior of the dome together with the main camera 101. So, the present invention is characterized in that the viewing angle is widened, and the inner space applicability of the dome is enhanced as compared to the conventional broadband monitoring camera which uses the assistant cameras 102 following preparing a separate space.

Meanwhile, the assistant cameras 102 having the same photographing directions as the main camera 101 among the four assistant cameras 102 can obtain the images except for the zoomed-in images when the main camera 101 photographs the zoomed-in image of a thing. So, when the main camera 101 zooms in a thing and photographs, the regions except for the zoomed-in images that the main camera 101 could not photograph, can be photographed by the assistant cameras 102, thus enhancing the monitoring performances.

Besides, the assistant bracket 114 has a hole, and a certain engage element such as a bolt, an insertion rubber, etc. might be formed in the hole. In this case, the engaging element can be engaged with a dome cover, thus fixing the broadband monitoring camera.

1. A broadband monitoring camera, comprising:
a main camera;
a plurality of assistant cameras which are installed near the main camera and serve to photograph a dear zone that the main camera cannot photograph;
a rotary type mounting part which provides a mounting space to the main camera for the main camera to rotate in the upward direction, the downward direction, the leftward direction and the rightward direction;
a mounting and engaging part which provides a mounting space for mounting the rotary type mounting part;
an assistant bracket which is engaged to the rotary type engaging part and provides a space for mounting the assistant cameras; and
an assistant camera support part which is engaged to the assistant bracket and mounts the assistant cameras,
wherein said assistant camera support parts are disposed for the assistant cameras to rotate in the upward direction, the downward direction, the leftward direction and the rightward direction, and said assistant camera support parts are engaged to the rotary type engaging part together with the assistant brackets and rotate or are fixed irrespective of the rotations of the rotary type engaging part as they are engaged to the mounting and engaging part together with the assistant brackets, so the assistant camera support parts can rotate or can be fixed.

2. A broadband monitoring camera according to claim 1, wherein said each assistant camera support part comprises:
a first lateral surface part in which a first support hole is formed;
a second lateral surface part in which a second support hole is formed; and
a support part which connects the first lateral surface part and the second lateral surface part and in which a third support hole is formed,
wherein said first lateral surface part and said second lateral surface part are bent at both ends of the support part, and said assistant cameras are bolt-engaged via the first support hole and the second support hole in a state that they are arranged between the first lateral surface part and the second lateral surface part, and said support part is characterized in that the bolt passing through the third support hole is bolt-engaged with the assistant bracket.

3. A broadband monitoring camera according to claim 2, wherein said first support hole and said second support hole are formed in a straight line shape.

4. A broadband monitoring camera according to claim 1, further comprising:
a first gear which is engaged with the rotary type engaging part;
a second gear which is spaced apart from the rotary type engaging part;
a first motor of which a motor shaft is engaged to the second gear and which is fixed at the mounting and engaging part;
a first belt which synchronically drives the first gear and the second gear;
a third gear of which a central shaft is inserted into the rotary type engaging part;
a fourth gear which is spaced apart from the third gear;
a second motor of which a motor shaft is engaged with the fourth gear and which is fixed at the rotary type engaging part; and
a second belt which synchronically drives the third gear and the fourth gear.
